(19) United States
(12) Patent Application Publication
(10) Pub. No.: US 2007/0244674 A1
(43) Pub. Date: Oct. 18, 2007

(54) Apparatus and method to monitor device status

(76) Inventors: Andrew Gary Hourselt, Tucson, AZ (US); John Thomas Olson, Tucson, AZ (US)

Correspondence Address: DALE F. REGELMAN, 4231 S. FREMONT AVENUE, TUCSON, AZ, 85714, US

(21) Appl. No.: 11/396,663

(22) Filed: Apr. 3, 2006

(51) Int. Cl. G06F 17/10

(52) U.S. Cl. 703/2

(57) ABSTRACT

A method is disclosed to monitor the status of devices disposed in a computing system. The method provides a computing device comprising a plurality of devices, and a system monitoring algorithm comprising a monitoring interval and a device status for each of (N) devices disposed in the computing device, where those (N) devices comprise a portion or all of the plurality of devices. The method sets for each value of (i), the (i)th monitoring interval and the (i)th device status, where the (i)th device status is selected from the group comprising active and inactive; where (i) is greater than or equal to 1 and less than or equal to (N). As long as the (i)th device status is set to active, the method monitors the status of the (i)th device at the expiration of each (i)th monitoring interval. On the other hand, as long as the (i)th device status is set to inactive, the method does not monitoring the status of the (i)th device at the expiration of each (i)th monitoring interval.

### FIELD OF THE INVENTION

The invention relates to monitoring the status, i.e. the operability, of devices disposed in a computing device.

### BACKGROUND OF THE INVENTION

It is known in the art to monitor the status of various devices disposed in a computing system using a monitoring system. If the monitoring system determines that a device is inoperable, a service notification is sent to a customer service organization. Field service personnel are dispatched to repair or replace the inoperable device.

Such prior art methods, however, tend to generate “false positive” results whereunder a device is reported as inoperable when that device has been intentionally taken out of service or placed in a standby mode.

What is needed is a method to monitor device status that is able to automatically adapt to changing system configurations and states.

### SUMMARY OF THE INVENTION

Applicants' invention comprises a method to monitor the status of devices disposed in a computing system. The method provides a computing system comprising a plurality of devices, and a system monitoring algorithm comprising a monitoring interval and a device status for each of (N) devices disposed in the computing device, where those (N) devices comprise a portion or all of the plurality of devices.

The method sets, for each value of (i), the (i)th monitoring interval and the (i)th device status, where the (i)th device status is selected from the group comprising active and inactive; where (i) is greater than or equal to 1 and less than or equal to (N). As long as the (i)th device status is set to active, the method monitors the status of the (i)th device at the expiration of each (i)th monitoring interval. On the other hand, as long as the (i)th device status is set to inactive, the method does not monitor the status of the (i)th device at the expiration of each (i)th monitoring interval.

### BRIEF DESCRIPTION OF THE DRAWINGS

The invention will be better understood from a reading of the following detailed description taken in conjunction with the drawings in which like reference designators are used to designate like elements, and in which:

FIG. 1A is a block diagram showing a first embodiment of Applicants' computing device;

FIG. 1B is a block diagram showing a second embodiment of Applicants' computing device;

FIG. 1C is a block diagram showing a third embodiment of Applicants' computing device;

FIG. 2 is a block diagram showing a fourth embodiment of Applicants' computing device;

FIG. 3 is a block diagram showing a fifth embodiment of Applicants' computing device;

FIG. 4 is a flow chart summarizing certain steps of Applicants' method;

FIG. 5 is a flow chart summarizing additional steps of Applicants' method; and

FIG. 6 is a flow chart summarizing additional steps of Applicants' method.

### DETAILED DESCRIPTION OF THE PREFERRED EMBODIMENTS

Referring to figures, wherein like parts are designated with the same reference numerals and symbols. Applicants' invention comprises a method to monitor the status of one or more devices disposed in a computing system. By “monitor the status of a device,” Applicants mean to determine the operability of that device.

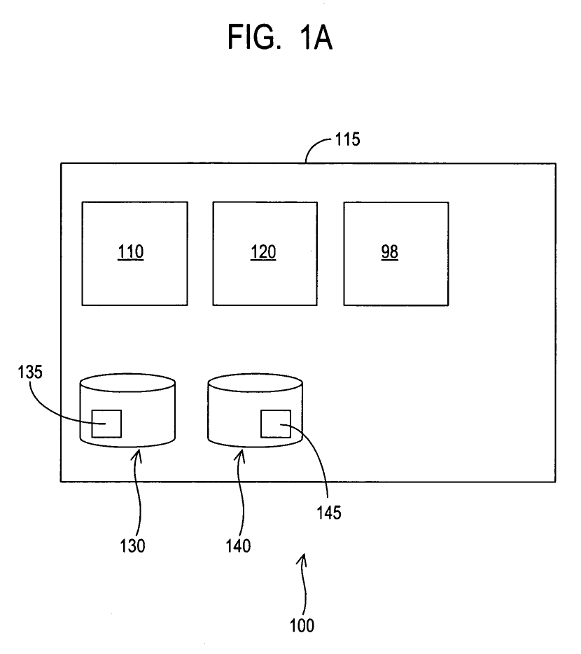

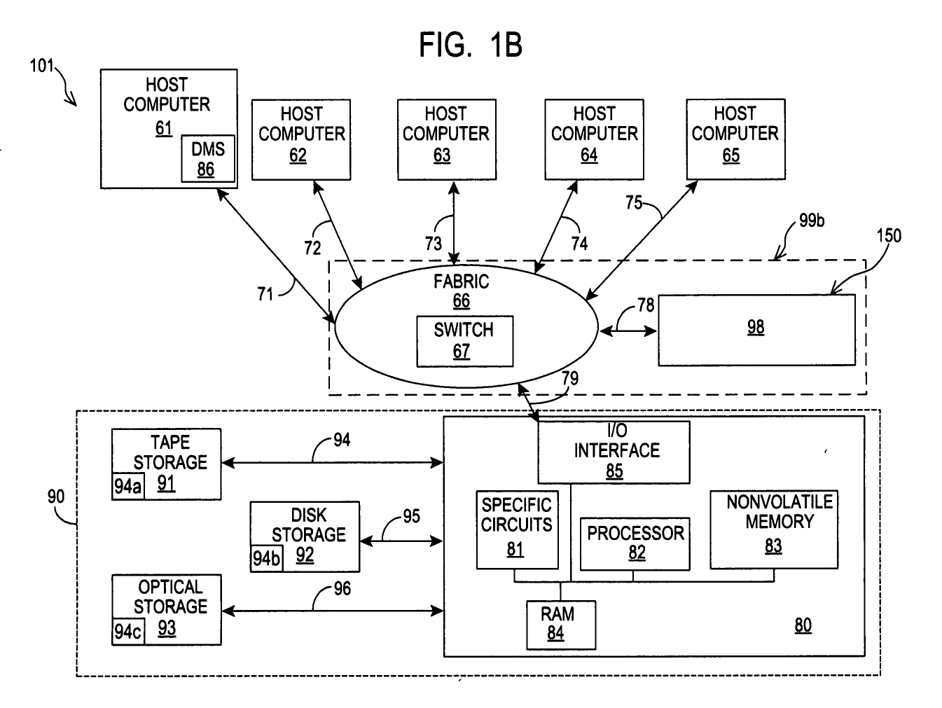

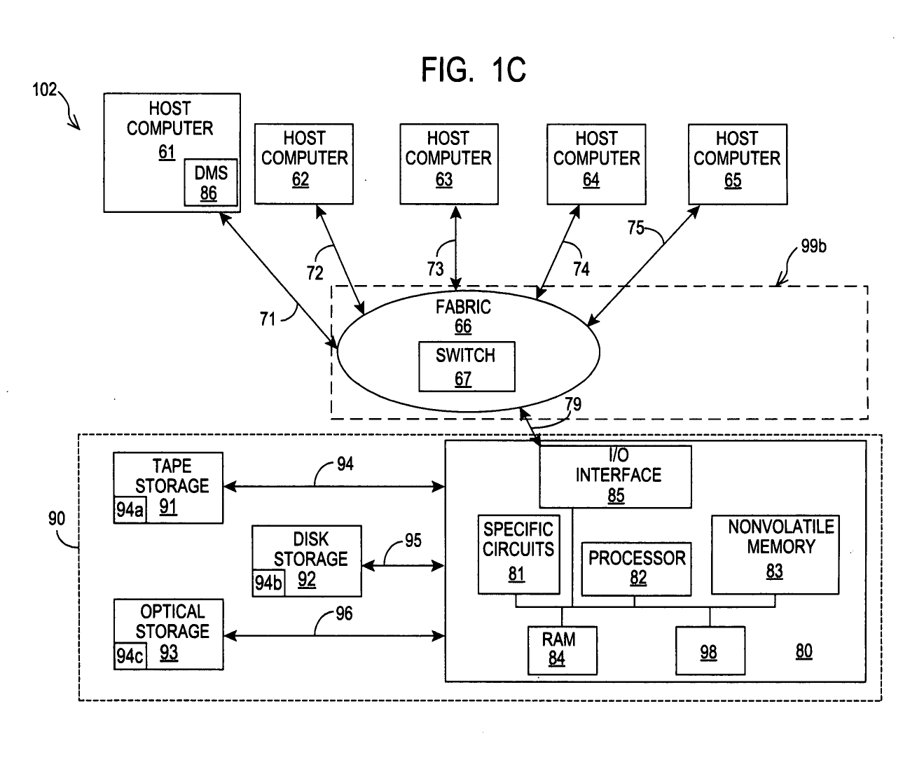

Referring now to FIG. 1A, in certain embodiments Applicants' computing system comprises computing system 100 comprising housing 115, processor 110, operating system 120, system monitoring algorithm 98, first data storage device 130, and optionally second data storage device 140. In the illustrated embodiment of FIG. 1, first data storage device 130 comprises device monitoring algorithm 135, and second data storage device 140 comprises device monitoring algorithm 145. In certain embodiments, data storage device 130 and/or data storage device 140, are disposed external to housing 115.

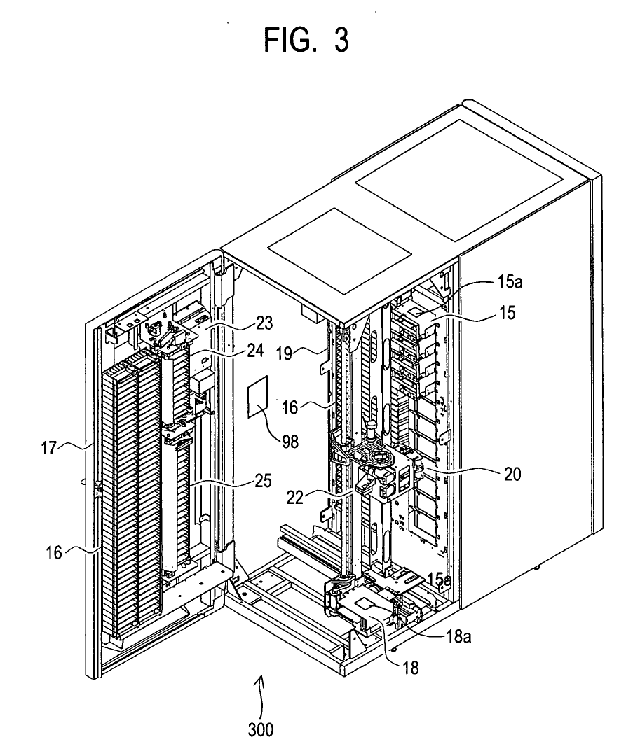

In certain embodiments, Applicants' computing device comprises a data storage system, such as system 300 (FIG. 3). Referring now to FIG. 3, data storage system 300 comprises a plurality of storage shelves 16 disposed on front wall 17 and rear wall 19, at least one data storage drive 15, and at least one accessor 18. In the illustrated embodiment of FIG. 3, accessor 18 comprises device monitoring algorithm 18a.

Accessor 18 is capable of removing a portable data storage medium from a storage shelf 16, transporting that data storage medium to drive 15, and mounting that data storage medium in data storage drive 15. In the illustrated embodiment of FIG. 3, data storage drive 15 comprises device monitoring algorithm 15a. In certain embodiments, the portable data storage medium is disposed in a portable housing, i.e. a cassette or cartridge.

Accessor 18 comprises a gripper assembly 20 for gripping one or more data storage media. In certain embodiments, accessor 18 further comprises a bar code scanner 22 or reading system, such as a smart card reader or similar system, mounted on the gripper 20.

Data storage system 300 optionally comprises operator panel 23, or other user interface, such as a web-based interface, which allows a user to interact with the library. In addition, data storage system 300 optionally comprises an upper I/O station 24 or a lower I/O station 25, which allows data storage media to be inserted into the library and/or removed from the library without disrupting library operation.

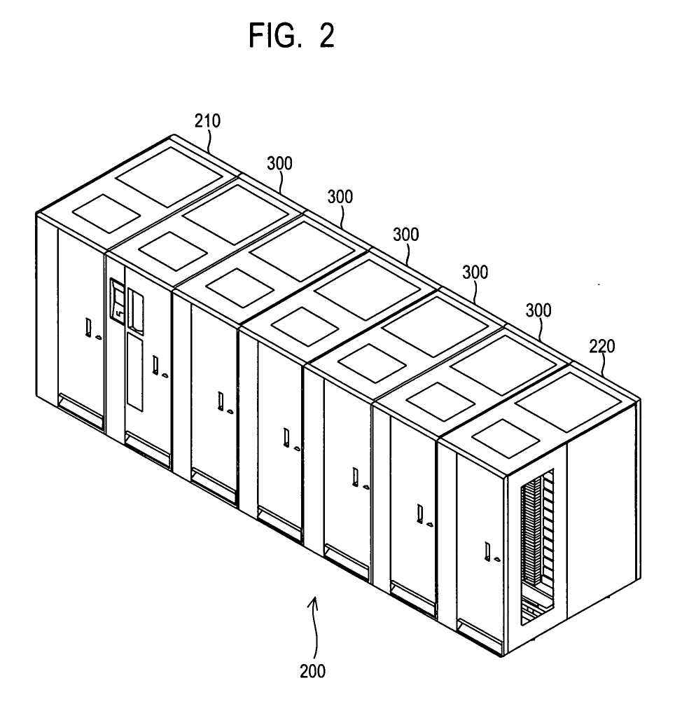

In certain embodiments, Applicants' data storage system comprises multiple systems 300. Referring now to FIG. 2, Applicants' data storage system 200 comprises left hand service bay 210, a plurality of data storage systems 300, and right hand service bay 220. In certain embodiments, data storage system 200 comprises the IBM 3584 UltraScalable Tape Library.

In certain embodiments, Applicants' computing device comprises a system which comprises a storage area network. Referring now to FIGS. 1B and 1C, Applicants' data storage systems 101 and 102 comprise a switched-access-network, wherein switches 67 are used to create a switching fabric 66. In certain embodiments, Applicants' storage area network is implemented using Small Computer Systems Interface (SCSI) protocol running over a Fibre Channel (“FC”) physical layer. In other embodiments, Applicants' storage area network utilizes other protocols, such as without limitation Infiniband, FICON, TCP/IP, Ethernet, Gigabit Ethernet, or iSCSI. The switches 67 have the addresses of both the hosts 61, 62, 63, 64, 65, and controller 80.

Host computers 61, 62, 63, 64, 65 are connected to the fabric 66 utilizing I/O interfaces 71, 72, 73, 74, 75 respectively. I/O interfaces 71-75 may be any type of I/O interface; for example, a FC arbitrated loop, a direct attachment to fabric 66 or one or more signal lines used by host computers 61-65 to transfer information respectfully to and from fabric 66. Fabric 66 includes, for example, one or more FC switches 67 used to connect two or more computer networks.

Switch 67 interconnects host computers 61-65 to controller 80 across I/O interface 79. I/O interface is used to transfer information respectfully to and from controller 80 and subsequently tape storage 91, disk storage 92, and optical storage 93. I/O interface 79 comprises any one or more types of known interface, for example, a Fibre Channel, Infiniband, Gigabit Ethernet, Ethernet, TCP/IP, iSCSI, SCSI I/O interface or one or more signal lines used by FC switch 67.

Data storage systems 101 and 102 comprise controller 80, tape storage device 91, disk storage device 92, and optical storage device 93. In other embodiments, data storage system 90 comprises a plurality of tape storage devices 91 and no disk storage devices 92 and no optical storage devices 93. In yet other embodiments, data storage system 90 comprises a plurality of disk storage devices 92 and no tape storage devices 91 and no optical storage devices 93. In still other embodiments, data storage system 90 comprises a plurality of optical storage devices 93 and no tape storage devices 91 and no disk storage devices 92.

Each tape storage device 91, disk storage device 92, optical storage device 93, comprises a device monitoring algorithm 94. Device monitoring algorithms 94a, 94b, and 94c, are in bidirectional communication with system monitoring algorithm 98.

In the illustrated embodiments of FIGS. 1B and 1C, controller 80 comprises processor 82, random access memory (“RAM”) 84, nonvolatile memory 83, specific circuits 81, and an I/O interface 85. In other embodiments, controller 80 is implemented entirely in software in one of hosts 61-65.

In certain embodiments, processor 82 comprises an off-the-shelf microprocessor. In certain embodiments, processor 82 comprises a custom processor. In certain embodiments, processor 82 comprises a FPGA. In certain embodiments, processor 82 comprises an ASIC. In certain embodiments, processor 82 comprises another form of discrete logic. RAM 84 is used to cache data being written by hosts 61-65 or being read for hosts 61-65, or hold calculated data, stack data, executable instructions, etc. Nonvolatile memory 83 may comprise any type of nonvolatile memory such as Electrically Erasable Programmable Read Only Memory (“EEPROM”), flash Programmable Read Only Memory (“PROM”), battery backup RAM, hard disk drive, or other similar device.

Nonvolatile memory 83 is used to hold the executable firmware and any nonvolatile data. I/O interface 85 comprises one or more communication interfaces which allow processor 82 to communicate with tape storage 91, disk storage 92, and optical storage 93, as well as Fabric 66. Examples of I/O interface 85 include serial interfaces such as RS-232, USB (Universal Serial Bus), SCSI (Small Computer Systems Interface), Fibre Channel, or Gigabit Ethernet, etc. In addition, I/O interface 85 may comprise a wireless interface such as radio frequency (“RF”) or Infrared.

The specific circuits 81 provide additional hardware to enable the controller 80 to perform unique functions, such as fan control for the environmental cooling of controller 80. Specific circuits 81 may comprise electronics that provide Pulse Width Modulation (PWM) control, Analog to Digital Conversion (ADC), Digital to Analog Conversion (DAC), etc. In addition, all or part of the specific circuits 81 may reside outside controller 80.

In certain embodiments, RAM 84 and/or nonvolatile memory 83 is disposed in processor 82. In certain embodiments, specific circuits 81 and/or I/O interface 78 is disposed within processor 82.

In the illustrated embodiment of FIG. 1B, monitoring appliance 150 is interconnected with fabric 66 via interface 78. System monitoring algorithm 98 is disposed in appliance 150. I/O interface 78 may be any type of I/O interface, for example, a Fibre Channel, Infiniband, Gigabit Ethernet, TCP/IP, iSCSI, SCSI I/O interface, or one or more signal lines used by FC switch 67 to transfer information respectfully to and from Network Attached Storage 98. Switch 67 interconnects library 90 to system monitoring algorithm 98 across I/O interface 78.

In the illustrated embodiment of FIG. 1C, system monitoring algorithm 98 is disposed in controller 80. In the illustrated embodiment of FIG. 1C, system monitoring algorithm communicates with tape storage device 91 via communication link 94, and with disk storage device 92 via communication link 95, and with optical storage device 97 via communication link 96.

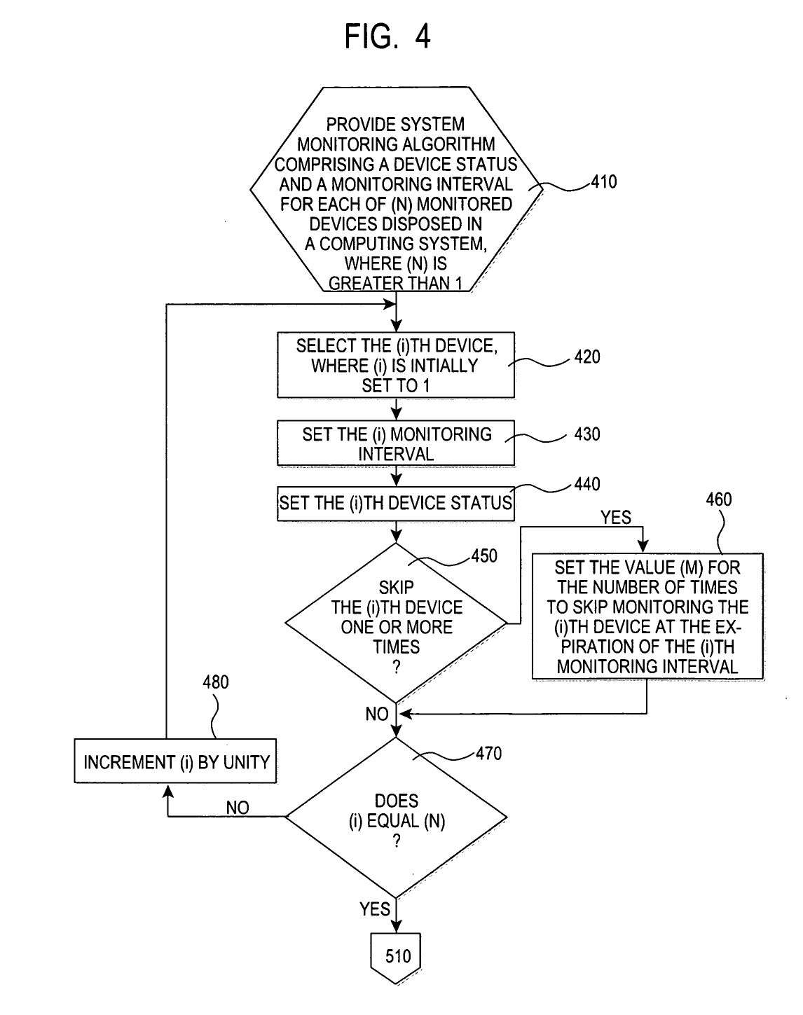

Applicants' method comprises a method to determine the operability of the monitored devices disposed within Applicants' computing system, such as computing system 100 (FIG. 1A), computing system 101 (FIG. 1B), computing system 102 (FIG. 1C, computing system 200 (FIG. 2), and computing system 300 (FIG. 3). Referring now to FIG. 4, in step 410 Applicants' method provides a system monitoring algorithm, such as algorithm 98 (FIGS. 1A, 1B, 1C, 3), wherein that system monitoring algorithm comprises a device status and a monitoring interval for each of (N) monitored devices disposed within the computing system. In certain embodiments, Applicants' computing device comprises a computer system, such as a mainframe, personal computer, workstation, and combinations thereof, including an operating system such as Windows, AIX, Unix, MVS, LINUX, etc. (Windows is a registered trademark of Microsoft Corporation; AIX is a registered trademark and MVS is a trademark of IBM Corporation; UNIX is a registered trademark in the United States and other countries licensed exclusively through The Open Group; and LINUX is a registered trademark of Linus Torvald). In other embodiments, Applicants' computing system comprises a data storage system, such as system 100 (FIG. 1).

In step 420, Applicants' method selects a first monitored device, i.e. the (i)th device wherein (i) is initially set to 1, such as for example tape storage device 91 (FIGS. 1B, 1C). In certain embodiments, step 420 is performed by the owner of the computing device comprising the (i)th device. In certain embodiments, step 420 is performed by the operator of the data storage system comprising the (i)th device. In certain embodiments, step 420 is performed by a processor/controller, such as processor 110 (FIG. 1A) or controller 80 (FIGS. 1B, 1C), disposed in the computing device comprising the (i)th monitored device. In certain embodiments, step 420 is performed by a system monitoring algorithm, such as algorithm 98 (FIGS. 1A, 1B, 1C), disposed in a system monitoring appliance, such as appliance 150 (FIG. 1B), in communication with Applicants' computing device.

In step 430, Applicants' method sets the (i)th monitoring interval, whereunder the method determines the operability of the (i)th device at each expiration of the (i)th monitoring interval. In certain embodiments, the (i)th monitoring interval comprises a time interval, such as and without limitation, 1 hour, 12 hours, 24 hours, 48 hours, 1 week, 2 weeks, 1 month, and the like. In certain embodiments, the (i)th monitoring interval comprises a number of device operations, such as and without limitation, the number of mounts performed by a tape storage device, the number of transports performed by an accessor, and the like.

In certain embodiments, step 430 is performed by the owner of the computing device comprising the (i)th device. In certain embodiments, step 430 is performed by the operator of the data storage system comprising the (i)th device. In certain embodiments, step 430 is performed by a processor/controller, such as processor 110 (FIG. 1A) or controller 80 (FIGS. 1B, 1C), disposed in the computing device comprising the (i)th monitored device. In certain embodiments, step 430 is performed by a system monitoring algorithm, such as algorithm 98 (FIGS. 1A, 1B, 1C), disposed in a system monitoring appliance, such as appliance 150 (FIG. 1B), in communication with Applicants' computing device.

In certain embodiments, the (i)th device comprises the (i)th device monitoring algorithm, such as device monitoring algorithm 94a (FIGS. 1B, 1C), and step 430 is performed by the (i)th device monitoring algorithm which provides the (i)th monitoring interval to the system monitoring algorithm, such as system monitoring algorithm 98 (FIGS. 1B, 1C). In certain embodiments, the (i)th device monitoring algorithm sets the (i)th monitoring interval based upon the number of operations performed by the (i)th device. For example, as the number of mounts performed by the (i)th tape storage device increases, the (i)th device monitoring algorithm disposed in the (i)th tape storage device decreases the (i)th monitoring interval. In certain embodiments, the (i)th monitoring algorithm comprises a lookup table that specifies the monitoring interval based upon the number of device operations performed.

In step 440, Applicants' method sets the (i)th device status. In certain embodiments, the (i)th device status is set as either “active” or “inactive.” In certain embodiments, step 440 is performed by the owner of the computing device comprising the (i)th device. In certain embodiments, step 440 is performed by the operator of the data storage system comprising the (i)th device. In certain embodiments, step 440 is performed by a processor/controller, such as processor 110 (FIG. 1A) or controller 80 (FIGS. 1B, 1C), disposed in the computing device comprising the (i)th monitored device. In certain embodiments, step 440 is performed by a system monitoring algorithm, such as algorithm 98 (FIGS. 1A, 1B, 1C), disposed in a system monitoring appliance, such as appliance 150 (FIG. 1B), in communication with Applicants' computing device.

In step 450, Applicants' method determines whether to set the (i)th device status as active but to skip device monitoring (M) times, wherein the method does not monitor the operability of the (i)th device for (M) monitoring intervals. In certain embodiments, step 450 is performed by the owner of the computing device comprising the (i)th device. In certain embodiments, step 450 is performed by the operator of the data storage system comprising the (i)th device. In certain embodiments, the (i)th device comprises the (i)th device monitoring algorithm, such as device monitoring algorithm 15a (FIG. 3), 18a (FIG. 3), 135 (FIG. 1), 145 (FIG. 1), 94a (FIGS. 1B, 1C), 94b (FIGS. 1B, 1C), and/or 94c (FIGS. 1B, 1C), and step 450 is performed by the (i)th device monitoring algorithm which provides the (i)th monitoring interval to the system monitoring algorithm, such as system monitoring algorithm 98 (FIGS. 1B, 1C). In certain embodiments, step 450 is performed by a processor/controller, such as processor 110 (FIG. 1A) or controller 80 (FIGS. 1B, 1C), disposed in the computing device comprising the (i)th monitored device.

If Applicants' method elects in step 450 not to set the (i)th device status as active but to skip device monitoring (M) times, then Applicants' method transitions from step 450 to step 470. Alternatively, if Applicants' method elects to set the (i)th device status as active but to skip device monitoring (M) times, then the method transitions from step 450 to step 460 wherein the method sets the value for (M). In certain embodiments, step 460 is performed by the owner of the computing device comprising the (i)th device. In certain embodiments, step 460 is performed by the operator of the data storage system comprising the (i)th device. In certain embodiments, the (i)th device comprises the (i)th device monitoring algorithm, such as device monitoring algorithm 94a (FIGS. 1B, 1C), and step 460 is performed by the (i)th device monitoring algorithm which provides the value of (M) to the system monitoring algorithm, such as system monitoring algorithm 98 (FIGS. 1B, 1C). In certain embodiments, step 460 is performed by a processor/controller, such as processor 110 (FIG. 1A) or controller 80 (FIGS. 1B, 1C), disposed in the computing device comprising the (i)th monitored device. In certain embodiments, step 460 is performed by a system monitoring algorithm, such as algorithm 98 (FIGS. 1A, 1B, 1C), disposed in a system monitoring appliance, such as appliance 150 (FIG. 1B), in communication with Applicants' computing device.

Applicants' method transitions from step 460 to step 470 wherein the method determines if the monitoring interval and device status have been set for all (N) monitored devices, i.e. if (i) equals (N). In certain embodiments, step 470 is performed by the owner of the computing device comprising the (i)th device. In certain embodiments, step 470 is performed by the operator of the data storage system comprising the (i)th device. In certain embodiments, the (i)th device comprises the (i)th device monitoring algorithm, such as device monitoring algorithm 94a (FIGS. 1B, 1C), and step 470 is performed by the (i)th device monitoring algorithm which provides the (i)th monitoring interval to the system monitoring algorithm, such as system monitoring algorithm 98 (FIGS. 1B, 1C). In certain embodiments, step 470 is performed by a processor/controller, such as processor 110 (FIG. 1A) or controller 80 (FIGS. 1B, 1C), disposed in the computing device comprising the (i)th monitored device. In certain embodiments, step 470 is performed by a system monitoring algorithm, such as algorithm 98 (FIGS. 1A, 1B, 1C), disposed in a system monitoring appliance, such as appliance 150 (FIG. 1B), in communication with Applicants' computing device.

If Applicants' method determines in step 470 that (i) does not equal (N), then the method transitions from step 470 to step 480 wherein the method increments (i) by unity, i.e. sets (i) equal to (i+1). In certain embodiments, step 480 is performed by the owner of the computing device comprising the (i)th device. In certain embodiments, step 480 is performed by the operator of the data storage system comprising the (i)th device. In certain embodiments, step 480 is performed by a processor/controller, such as processor 110 (FIG. 1A) or controller 80 (FIGS. 1B, 1C), disposed in the computing device comprising the (i)th monitored device. In certain embodiments, step 480 is performed by a system monitoring algorithm, such as algorithm 98 (FIGS. 1A, 1B, 1C), disposed in a system monitoring appliance, such as appliance 150 (FIG. 1B), in communication with Applicants' computing device.

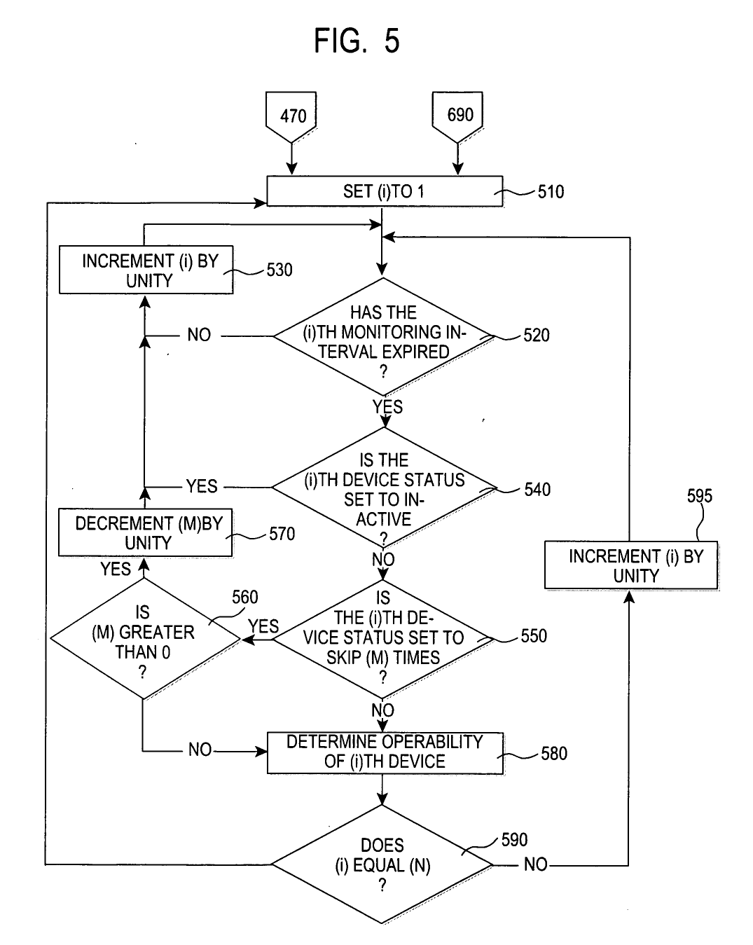

If Applicants' method determines in step 470 that (i) does equal (N), then the method transitions from step 470 to step 510 (FIG. 5).

Referring now to FIG. 5, in step 510 Applicants' method sets (i) to 1. In certain embodiments, step 510 is performed by the owner of the computing device comprising the (i)th device. In certain embodiments, step 510 is performed by the operator of the data storage system comprising the (i)th device. In certain embodiments, step 510 is performed by a processor/controller, such as processor 110 (FIG. 1A) or controller 80 (FIGS. 1B, 1C), disposed in the computing device comprising the (i)th monitored device. In certain embodiments, step 510 is performed by a system monitoring algorithm, such as algorithm 98 (FIGS. 1A, 1B, 1C), disposed in a system monitoring appliance, such as appliance 150 (FIG. 1B), in communication with Applicants' computing device.

Applicants' method transitions from step 510 to step 520 wherein the method determines if the (i)th monitoring interval has expired. In certain embodiments, step 520 performed by the owner of the computing device comprising the (i)th device. In certain embodiments, step 520 is performed by the operator of the data storage system comprising the (i)th device. In certain embodiments, step 520 is performed by a processor/controller, such as processor 110 (FIG. 1A) or controller 80 (FIGS. 1B, 1C), disposed in the computing device comprising the (i)th monitored device. In certain embodiments, step 520 is performed by a system monitoring algorithm, such as algorithm 98 (FIGS. 1A, 1B, 1C), disposed in a system monitoring appliance, such as appliance 150 (FIG. 1B), in communication with Applicants' computing device.

If Applicants' method determines in step 520 that the (i)th monitoring interval has not expired, then the method transitions from step 520 to step 530 wherein the method increments (i) by unity. In certain embodiments, step 530 is performed by the owner of the computing device comprising the (i)th device. In certain embodiments, step 530 is performed by the operator of the data storage system comprising the (i)th device. In certain embodiments, step 530 is performed by a processor/controller, such as processor 110 (FIG. 1A) or controller 80 (FIGS. 1B, 1C), disposed in the computing device comprising the (i)th monitored device. In certain embodiments, step 530 is performed by a system monitoring algorithm, such as algorithm 98 (FIGS. 1A, 1B, 1C, 3), disposed in a system monitoring appliance, such as appliance 150 (FIG. 1B), in communication with Applicants' computing device.

If Applicants' method determines in step 520 that the (i)th monitoring interval has expired, then the method transitions from step 520 to step 540 wherein the method determines if the (i)th device status is set to inactive. In certain embodiments, step 540 is performed by the owner of the computing device comprising the (i)th device. In certain embodiments, step 540 is performed by the operator of the data storage system comprising the (i)th device. In certain embodiments, step 540 is performed by a processor/controller, such as processor 110 (FIG. 1A) or controller 80 (FIGS. 1B, 1C), disposed in the computing device comprising the (i)th monitored device. In certain embodiments, step 540 is performed by a system monitoring algorithm, such as algorithm 98 (FIGS. 1A, 1B, 1C, 3), disposed in a system monitoring appliance, such as appliance 150 (FIG. 1B), in communication with Applicants' computing device.

If Applicants' method determines in step 540 that the (i)th device status is set to inactive, then the method transitions from step 540 to step 530 and continues as described herein. Alternatively, if Applicants' method determines in step 540 that the (i)th device status is not set to inactive, then the method transitions from step 540 to step 550 wherein the method determines if the (i)th device status is set to active but also set to skip (M) monitoring intervals. In certain embodiments, step 550 is performed by the owner of the computing device comprising the (i)th device. In certain embodiments, step 550 is performed by the operator of the data storage system comprising the (i)th device. In certain embodiments, step 550 is performed by a processor/controller, such as processor 110 (FIG. 1A) or controller 80 (FIGS. 1B, 1C), disposed in the computing device comprising the (i)th monitored device. In certain embodiments, step 550 is performed by a system monitoring algorithm, such as algorithm 98 (FIGS. 1A, 1B, 1C), disposed in a system monitoring appliance, such as appliance 150 (FIG. 1B), in communication with Applicants' computing device.

If Applicants' method determines in step 550 that the (i)th device status is not set to active but to skip (M) monitoring intervals, then the method transitions from step 550 to step 580. If Applicants' method determines in step 550 that the (i)th device status is set to active but also set to skip (M) monitoring intervals, then the method transitions from step 550 to step 560 wherein the method determines if (M) is greater than 0. In certain embodiments, step 560 is performed by the owner of the computing device comprising the (i)th device. In certain embodiments, step 560 is performed by the operator of the data storage system comprising the (i)th device. In certain embodiments, step 560 is performed by a processor/controller, such as processor 110 (FIG. 1A) or controller 80 (FIGS. 1B, 1C), disposed in the computing device comprising the (i)th monitored device. In certain embodiments, step 560 is performed by a system monitoring algorithm, such as algorithm 98 (FIGS. 1A, 1B, 1C), disposed in a system monitoring appliance, such as appliance 150 (FIG. 1B), in communication with Applicants' computing device.

If Applicants' method determines in step 560 that (M) is not greater than 0, then the method transitions from step 560 to step 570 wherein the method decrements (M) by unity, i.e. sets (M) equal to (M−1). In certain embodiments, step 570 is performed by the owner of the computing device comprising the (i)th device. In certain embodiments, step 570 is performed by the operator of the data storage system comprising the (i)th device. In certain embodiments, step 570 is performed by a processor/controller, such as processor 110 (FIG. 1A) or controller 80 (FIGS. 1B, 1C), disposed in the computing device comprising the (i)th monitored device. In certain embodiments, step 570 is performed by a system monitoring algorithm, such as algorithm 98 (FIGS. 1A, 1B, 1C), disposed in a system monitoring appliance, such as appliance 150 (FIG. 1B), in communication with Applicants' computing device. Applicants' method transitions from step 570 to step 530 and continues as described herein.

If Applicants' method determines in step 560 that (M) is not greater than 0, then the method transitions from step 560 to step 580 wherein the method determines the operability of the (i)th device. In certain embodiments, step 580 comprises sending a signal, i.e. a “ping,” to the (i)th device which upon receipt of that “ping” responds in kind. Receipt of the responding “ping” indicates that the (i)th device is operable. On the other hand, failure to receive a responding “ping” from the (i)th device indicates that the (i)th device is inoperable. In certain embodiments, step 580 comprises executing a program on the (i)th device, and receiving a valid return code which indicates that the (i)th device is operable. In certain embodiments, step 580 further comprises generating an error alert in the event a responding “ping” or valid return code is not received from the (i)th device.

In certain embodiments, step 580 is performed by the owner of the computing device comprising the (i)th device. In certain embodiments, step 580 is performed by the operator of the data storage system comprising the (i)th device. In certain embodiments, step 580 is performed by a processor/controller, such as processor 110 (FIG. 1A) or controller 80 (FIGS. 1B, 1C), disposed in the computing device comprising the (i)th monitored device. In certain embodiments, step 580 is performed by a system monitoring algorithm, such as algorithm 98 (FIGS. 1A, 1B, 1C), disposed in a system monitoring appliance, such as appliance 150 (FIG. 1B), in communication with Applicants' computing device.

Applicants' method transitions from step 580 to step 590 wherein the method determines if the operability of each of the (N) monitored devices has been determined, i.e. if (i) equals (N). In certain embodiments, step 590 is performed by the owner of the computing device comprising the (i)th device. In certain embodiments, step 590 is performed by the operator of the data storage system comprising the (i)th device. In certain embodiments, step 590 is performed by a processor/controller, such as processor 110 (FIG. 1A) or controller 80 (FIGS. 1B, 1C), disposed in the computing device comprising the (i)th monitored device. In certain embodiments, step 590 is performed by a system monitoring algorithm, such as algorithm 98 (FIGS. 1A, 1B, 1C), disposed in a system monitoring appliance, such as appliance 150 (FIG. 1B), in communication with Applicants' computing device.

If Applicants' method determines in step 590 that (i) equals (N), then the method transitions from step 590 to step 510 and continues as described herein. Alternatively, if Applicants' method determines in step 590 that (i) does not equal (N), then the method transitions from step 590 to step 595 wherein the method increments (i) by unity. In certain embodiments, step 595 is performed by the owner of the computing device comprising the (i)th device. In certain embodiments, step 595 is performed by the operator of the data storage system comprising the (i)th device. In certain embodiments, step 595 is performed by a processor/controller, such as processor 110 (FIG. 1A) or controller 80 (FIGS. 1B, 1C), disposed in the computing device comprising the (i)th monitored device. In certain embodiments, step 595 is performed by a system monitoring algorithm, such as algorithm 98 (FIGS. 1A, 1B, 1C), disposed in a system monitoring appliance, such as appliance 150 (FIG. 1B), in communication with Applicants' computing device. Applicants' method transitions from step 595 to step 520 and continues as described herein.

From time to time, a device is intentionally taken out of service for repair, or to be placed in a standby mode. Prior art methods continue to monitor the status of that device, and necessarily report that device as inoperable. Thus, prior art methods generate what are sometimes referred to as “false positives” whereunder an inactive device is reported as inoperable. Applicants' method sets the device status for such an intentionally disabled device to inactive. Thereafter, Applicants' method does not determine the operability of that device.

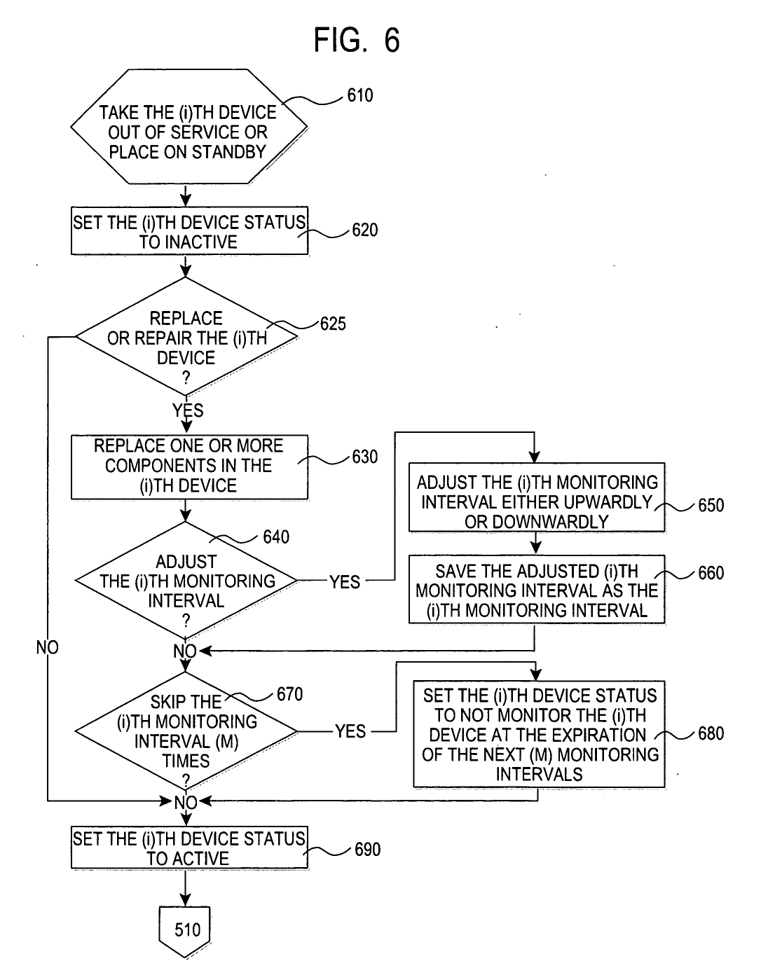

Referring now to FIG. 6, in step 610 Applicants' method takes the (i)th device out of service. In step 620, Applicants' method sets the (i)th device status to inactive. In certain embodiments, step 620 is performed by the owner of the computing device comprising the (i)th device. In certain embodiments, step 620 is performed by the operator of the data storage system comprising the (i)th device.

Applicants' method transitions from step 620 to step 625 wherein the method determines if the (i)th device will be repaired or replaced. In certain embodiments, the (i)th device is intentionally placed in a standby mode, wherein the (i)th device is taken out of service but does not need to be either repaired or replaced. In these embodiments, Applicants' method transitions from step 625 to step 690.

In other embodiments, Applicants' method determines in step 625 that the (i)th device requires repair or replacement. In these embodiments, Applicants' method transitions from step 625 to step 630 wherein the method replaces or repairs one or more components disposed in the (i)th device. In certain embodiments, step 630 comprises replacing and/or repairing one or more hardware elements disposed in the (i)th device. In certain embodiments, step 630 comprises replacing and/or repairing one or more firmware elements disposed in the (i)th device. In certain embodiments, step 630 comprises replacing and/or repairing one or more software elements disposed in the (i)th device.

In step 640, Applicants' method determines whether to adjust the (i)th monitoring interval based upon the repaired and/or replaced elements. In certain embodiments, step 640 is performed by the owner of the computing device comprising the (i)th device. In certain embodiments, step 640 is performed by the operator of the data storage system comprising the (i)th device. In certain embodiments, the (i)th device comprises the (i)th device monitoring algorithm, such as device monitoring algorithm 94a (FIGS. 1B, 1C), and step 640 is performed by the (i)th device monitoring algorithm which provides the (i)th monitoring interval to the system monitoring algorithm, such as system monitoring algorithm 98 (FIGS. 1B, 1C).

If Applicants' method elects not to adjust the (i)th monitoring interval, then the method transitions from step 640 to step 670. Alternatively, if Applicants' method elects to adjust the (i)th monitoring interval, then the method transitions from step 640 to step 650 wherein the method adjusts the (i)th monitoring interval upwardly or downwardly. If the repair and/or replacement of step 630 increases the reliability of the (i)th device, then in step 650 Applicants' method increases the (i)th monitoring interval. On the other hand, if the repair and/or replacement of step 630 indicates that the (i)th device comprises a particular unreliable components, then in step 650 Applicants' method decreases the (i)th monitoring interval.

In certain embodiments, step 650 is performed by the owner of the computing device comprising the (i)th device. In certain embodiments, step 650 is performed by the operator of the data storage system comprising the (i)th device. In certain embodiments, the (i)th device comprises the (i)th device monitoring algorithm, such as device monitoring algorithm 94a (FIGS. 1B, 1C), and step 650 is performed by the (i)th device monitoring algorithm which provides the (i)th monitoring interval to the system monitoring algorithm, such as system monitoring algorithm 98 (FIGS. 1B, 1C).

Applicants' method transitions from step 650 to step 660 wherein the method saves the adjusted (i)th monitoring interval of step 650 as the (i)th monitoring interval. In certain embodiments, step 660 is performed by the owner of the computing device comprising the (i)th device. In certain embodiments, step 660 is performed by the operator of the data storage system comprising the (i)th device. In certain embodiments, the (i)th device comprises the (i)th device monitoring algorithm, such as device monitoring algorithm 94a (FIGS. 1B, 1C), and step 660 is performed by the (i)th device monitoring algorithm which provides the (i)th monitoring interval to the system monitoring algorithm, such as system monitoring algorithm 98 (FIGS. 1B, 1C).

Applicants' method transitions from step 660 to step 670 wherein the method determines whether to skip the next (M) monitoring intervals. For example and without limitation, if the repair and/or replacement of step 630 increases the reliability of the (i)th device, Applicants' method may elect not to increase the (i)th monitoring interval, but to skip the next (M) unadjusted monitoring intervals. In certain embodiments, step 670 is performed by the owner of the computing device comprising the (i)th device. In certain embodiments, step 670 is performed by the operator of the data storage system comprising the (i)th device. In certain embodiments, the (i)th device comprises the (i)th device monitoring algorithm, such as device monitoring algorithm 94a (FIGS. 1B, 1C), and step 670 is performed by the (i)th device monitoring algorithm which provides the (i)th monitoring interval to the system monitoring algorithm, such as system monitoring algorithm 98 (FIGS. 1B, 1C).

If Applicants' method elects not to skip the next (M) monitoring intervals for the (i)th device, then the method transitions from step 670 to step 690. Alternatively, if Applicants' method elects to skip the next (M) monitoring intervals for the (i)th device, then the method transitions from step 670 to step 680 wherein the method sets the value of (M). In certain embodiments, step 680 is performed by the owner of the computing device comprising the (i)th device. In certain embodiments, step 680 is performed by the operator of the data storage system comprising the (i)th device. In certain embodiments, the (i)th device comprises the (i)th device monitoring algorithm, such as device monitoring algorithm 94a (FIGS. 1B, 1C), and step 680 is performed by the (i)th device monitoring algorithm which provides the (i)th monitoring interval to the system monitoring algorithm, such as system monitoring algorithm 98 (FIGS. 1B, 1C).

Applicants' method transitions from step 680 to step 690 wherein the method sets the (i)th device status to active. In certain embodiments, step 690 is performed by the owner of the computing device comprising the (i)th device. In certain embodiments, step 690 is performed by the operator of the data storage system comprising the (i)th device. In certain embodiments, the (i)th device comprises the (i)th device monitoring algorithm, such as device monitoring algorithm 94a (FIGS. 1B, 1C), and step 690 is performed by the (i)th device monitoring algorithm which provides the (i)th device status to the system monitoring algorithm, such as system monitoring algorithm 98 (FIGS. 1B, 1C). Applicants' method transitions from step 690 to step 510 and continues as described herein.

In certain embodiments, individual steps recited in FIGS. 4 and/or 5 and/or 6 may be combined, eliminated, or reordered.

In certain embodiments, Applicants' invention includes instructions residing in a system monitoring algorithm, such as algorithm 98 (FIGS. 1A, 1B, 1C, 3), and/or in a device monitoring algorithm, such as algorithm 15a, algorithm 18a, algorithm 135 (FIG. 1A) and/or algorithm 145 (FIG. 1A), and/or algorithm 94a (FIGS. 1B, 1C), and/or algorithm 94b (FIGS. 1B, 1C), and/or algorithm 94c (FIGS. 1B, 1C), where those instructions are executed by a processor, such as processor 110 (FIG. 1A) and/or controller 80 (FIGS. 1B, 1C), and/or appliance 150 (FIG. 1B), to perform one or more of steps 420, 430, 440, 450, 460, 470, and 480, recited in FIG. 4, and/or one or more of steps 510, 520, 530, 540, 550, 560, 570, 580, and 590, recited in FIG. 5, and/or one or more of steps 640, 650, 660, 670, 680, and 690, recited in FIG. 6.

In other embodiments, Applicants' invention includes instructions residing in any other computer program product, where those instructions are executed by a computer external to, or internal to, computing device 100 (FIG. 1A), data storage system 101 (FIG. 1B), data storage system 102 (FIG. 1C), computing device 200 (FIG. 2), and/or computing device 300 (FIG. 3), t to perform one or more of steps 420, 430, 440, 450, 460, 470, and 480, recited in FIG. 4, and/or one or more of steps 510, 520, 530, 540, 550, 560, 570, 580, and 590, recited in FIG. 5, and/or one or more of steps 640, 650, 660, 670, 680, and 690, recited in FIG. 6. In either case, the instructions may be encoded in an information storage medium comprising, for example, a magnetic information storage medium, an optical information storage medium, an electronic information storage medium, and the like. By “electronic storage media,” Applicants mean, for example, a device such as a PROM, EPROM, EEPROM, Flash PROM, compactflash, smartmedia, and the like.

While the preferred embodiments of the present invention have been illustrated in detail, it should be apparent that modifications and adaptations to those embodiments may occur to one skilled in the art without departing from the scope of the present invention as set forth in the following claims.

We claim:

1. A method to monitor the status of devices disposed in a computing system, comprising the steps of:
providing a computing device comprising a plurality of devices;
providing a system monitoring algorithm comprising a monitoring interval and a device status for each of (N) devices disposed in said computing device, wherein said (N) devices comprise a portion or all of said plurality of devices, wherein each of said (N devices are in bidirectional communication with said system monitoring algorithm;
for each value of (i), setting the (i)th monitoring interval for the (i)th device, wherein (i) is greater than or equal to 1 and less than or equal to (N);
for each value of (i), setting the (i)th device status, wherein the (i)th device status is selected from the group comprising active and inactive;
as long as the (i)th device status is set to active, monitoring by said system monitoring algorithm the status of the (i)th device at the expiration of each (i)th monitoring interval;

2. The method of claim 1, further comprising the step of not monitoring the status of the (i)th device at the expiration of each (i)th monitoring interval as long as the (i)th device status is set to inactive.

3. The method of claim 1, wherein the device status for each of said (N) devices is further selected from the group comprising active, inactive, and skip (M) times, further comprising:
for each value of (i), determining if the (i)th monitoring interval is expired;
operative if the (i)th monitoring interval is expired, determining if the (i)th device status is set to skip (M) times, wherein (M) is greater than 0;
operative if the (i)th device status if set to skip (M) times, wherein (M) is greater than 0:
not monitoring the status of the (i)th device; and
revising said (i)th device status by decrementing (M) by unity;
saving said revised (i)th device status.

4. The method of claim 1, wherein said providing a plurality of devices step further comprises providing the (i)th device comprising an (i)th device monitoring algorithm.

5. The method of claim 4, wherein the (i)th monitoring interval comprises a first value, further comprising the steps of:
replacing one or more components disposed in the (i)th device;
revising said (i)th monitoring interval to comprise a second value, wherein said second value is greater than said first value.

6. The method of claim 5, wherein said (i)th device monitoring algorithm generates said revised (i)th monitoring interval.

7. The method of claim 6, wherein said (i)th device monitoring algorithm provides said revised (i)th monitoring interval to said system monitoring algorithm.

8. The method of claim 4, further comprising the steps of:
revising said (i)th monitoring interval by said (i)th device monitoring algorithm upon the number of device operations performed by said (i)th device;
providing by said (i)th device monitoring algorithm said revised (i)th monitoring interval to said system monitoring algorithm.

9. The method of claim 1, further comprising the step of providing a data storage system comprising a plurality of data storage devices, wherein said data storage system comprises said computing device, and wherein each of said plurality of data storage devices comprises one of said (N) devices.

10. An article of manufacture comprising a plurality of devices and a computer useable medium having computer readable program code disposed therein to monitor the status of each of (N) devices disposed in said article of manufacture, wherein said (N) devices comprise a portion or all of said plurality of devices, providing a system monitoring algorithm comprising a monitoring interval and a device status for e the computer readable program code comprising a series of computer readable program steps to effect:
for each value of (i), retrieving a predetermined (i)th device status and a predetermined (i)th monitoring interval for the (i)th device, wherein (i) is greater than or equal to 1 and less than or equal to (N);
as long as the (i)th device status is set to active, monitoring the status of the (i)th device at the expiration of each (i)th monitoring interval.

11. The article of manufacture of claim 10, said computer readable program code further comprising a series of computer readable program steps to effect not monitoring the status of the (i)th device at the expiration of each (i)th monitoring interval as long as the (i)th device status is set to inactive.

12. The article of manufacture of claim 10, said computer readable program code further comprising a series of computer readable program steps to effect:
for each value of (i), determining if the (i)th monitoring interval is expired;
operative if the (i)th monitoring interval is expired, determining if the (i)th device status is set to skip (M) times, wherein (M) is greater than 0;
operative if the (i)th device status if set to skip (M) times, wherein (M) is greater than 0:
not monitoring the status of the (i)th device;
revising said (i)th device status by decrementing (M) by unity;
saving said revised (i)th device status.

13. The article of manufacture of claim 10, said computer readable program code further comprising a series of computer readable program steps to effect receiving from the (i)th device a revised (i)th monitoring interval.

14. The article of manufacture of claim 13, said computer readable program code further comprising a series of computer readable program steps to effect receiving said revised (i)th monitoring interval from an (i)th device monitoring algorithm.

15. The article of manufacture of claim 14, said computer readable program code further comprising a series of computer readable program steps to effect saving said revised (i)th monitoring interval as the (i)th monitoring interval.

16. The article of manufacture of claim 11, wherein said article of manufacture comprises a data storage system comprising a plurality of data storage devices, wherein each of said plurality of data storage devices comprises one of said (N) devices.

17. A computer program product usable with a programmable computer processor having computer readable program code embodied therein to monitor the status of (N) devices disposed in a computing system, wherein (N) is greater than 1, comprising:
computer readable program code which causes said programmable computer processor to, for each value of (i), retrieve a predetermined (i)th device status and a predetermined (i)th monitoring interval, wherein (i) is greater than or equal to 1 and less than or equal to (N);
computer readable program code which, as long as the (i)th device status is set to active, causes said programmable computer processor to monitor by the status of the (i)th device at the expiration of each (i)th monitoring interval.

18. The computer program product of claim 17, further comprising computer readable program code which, as long as the (i)th device status is set to inactive, causes said programmable computer processor to not monitor the status of the (i)th device at the expiration of each (i)th monitoring interval.

19. The computer program product of claim 17, further comprising:
computer readable program code which, for each value of (i), causes said programmable computer processor to determine if the (i)th monitoring interval is expired;
computer readable program code which, if the (i)th monitoring interval is expired, causes said programmable computer processor to determine if the (i)th device status is set to skip (M) times, wherein (M) is greater than 0;
computer readable program code which, if the (i)th device status if set to skip (M) times, wherein (M) is greater than 0, causes said programmable computer processor to:
not monitor the status of the (i)th device;
revise said (i)th device status by decrementing (M) by unity;
save said revised (i)th device status.

20. The computer program product of claim 17, further comprising computer readable program code which causes said programmable computer processor to receive a revised (i)th monitoring interval from the (i)th device.

21. The computer program product of claim 20, further comprising computer readable program code which causes said programmable computer processor to receive said revised (i)th monitoring interval from an (i)th device monitoring algorithm.

22. The computer program product of claim 21, further comprising computer readable program code which causes said programmable computer processor to save said revised (i)th monitoring interval as the (i)th monitoring interval.

23. A method to provide data storage services by a data storage services provider to one or more data storage services customers, comprising the steps of:
providing a computing device comprising a plurality of data storage devices;
receiving customer data from one of said one or more data storage services customers;
writing said customer data to one or more of said plurality of data storage devices;
providing a system monitoring algorithm comprising a monitoring interval and a device status for each of (N) data storage devices disposed in said computing device, wherein said (N) data storage devices comprise a portion or all of said plurality of data storage devices, wherein each of said (N) data storage devices are in bidirectional communication with said system monitoring algorithm;
for each value of (i), setting the (i)th monitoring interval for the (i)th data storage device, wherein (i) is greater than or equal to 1 and less than or equal to (N);
for each value of (i), setting the (i)th device status, wherein the (i)th device status selected from the group comprising active and inactive;
as long as the (i)th device status is set to active, monitoring by said system monitoring algorithm the status of the (i)th data storage device at the expiration of each (i)th monitoring interval;
as long as the (i)th device status is set to inactive, not monitoring by said system monitoring algorithm the status of the (i)th data storage device at the expiration of each (i)th monitoring interval.
